(19) United States
(12) Patent Application Publication
(10) Pub. No.: US 2025/0174017 A1
(43) Pub. Date: May 29, 2025

(54) OBJECT DETECTION DEVICE, OBJECT DETECTION METHOD, AND OBJECT DETECTION PROGRAM

(71) Applicant: NIPPON TELEGRAPH AND TELEPHONE CORPORATION, Tokyo (JP)

(72) Inventors: Hiroyuki UZAWA, Tokyo (JP); Saki HATTA, Tokyo (JP); Shuhei YOSHIDA, Tokyo (JP); Yuko IINUMA, Tokyo (JP); Daisuke KOBAYASHI, Tokyo (JP); Yuya OMORI, Tokyo (JP); Yusuke HORISHITA, Tokyo (JP); Ken NAKAMURA, Tokyo (JP)

(73) Assignee: NIPPON TELEGRAPH AND TELEPHONE CORPORATION, Tokyo (JP)

(21) Appl. No.: 18/868,738

(22) PCT Filed: May 26, 2022
(86) PCT No.: PCT/JP2022/021587

§ 371 Date: Nov. 23, 2024

(51) Int. Cl. G06V 10/82; G06T 7/73; G06V 10/764; G06V 10/776

(52) U.S. Cl. CPC G06V 10/82; G06T 7/73; G06V 10/764; G06V 10/776; G06T 2207/20084; G06V 2201/10

(57) ABSTRACT

An object detection device 10 including a metadata acquisition unit 103, a storage unit 104, and a feature map value acquisition unit 105 is provided. The metadata acquisition unit 103 acquires metadata including at least a position and reliability of an object included in an image from a convolutional neural network into which the image is input. The storage unit 104 stores a feature map value group which is an output result of the convolutional neural network. The feature map value acquisition unit 105 reads a feature map value related to the position of the corresponding object from the storage unit 104 to obtain the position of the object only when the reliability obtained by reading a feature map value, which is related to the reliability in the feature map value group stored in the storage unit 104, from the storage unit 104 exceeds a predetermined threshold value.

### TECHNICAL FIELD

The disclosed technology relates to an object detection device, an object detection method, and an object detection program.

### BACKGROUND ART

There is an object identification device that outputs a bounding box (BB) including object position coordinates, classes (types of persons, vehicles, and the like.) and a reliability included in an input image from the image. In recent years, You Only Look Once (YOLO) and a single shot multibox detector (SSD) which enable the output of a BB in a single convolutional neural network (CNN) have been disclosed. The technology of an object identification device being applied to an edge or a terminal such as a monitoring camera and drone control has been studied.

In object detection based on a CNN such as YOLO, detection processing for obtaining a BB is executed in a final layer based on a feature map value obtained by an immediately previous CNN operation. FIG. 1 is a diagram showing a processing flow of a CNN including detection processing. In YOLO or an SSD, feature map values corresponding to predetermined Bₙᵤₘ BB (B[0] to B[Bₙᵤₘ−1]) are obtained by the CNN for each unit referred to as a Grid obtained by dividing an image of horizontal W pixels by vertical H pixels. The feature map values of the CNN output include values (tx, ty, tw, th) corresponding to the coordinates of the BB, a value (p_{obj}) corresponding to a reliability (object reliability) for the presence or absence of an object at the coordinates, and values (p[0] to p[Cₙᵤₘ−1, Cₙᵤₘ: the number of classes) corresponding to the reliability for each class of the object. In the detection processing, these feature map values are converted into BBs, BBs in which an object reliability obtained as a result of the conversion is equal to or less than a threshold value are removed, and duplicate BBs are removed (non-maximum-suppression: NMS).

A method for executing CNN-based object detection in real time is disclosed (NPL 1 and NPL 2).

### CITATION LIST

### Non Patent Literature

[NPL 1] H. Nakahara et al, “A Demonstration of FPGA-Based You Only Look Once Version2 (YOLOv2),” 2018 28th International Conference on Field Programmable Logic and Applications (FPL), 2018, pp. 457-4571.
[NPL 2] H. Uzawa et al, “High-definition object detection technology based on AI inference scheme and its implementation”, IEICE Electronics Express, 2021, Volume 18, Issue 22, Pages 2021032

### SUMMARY OF INVENTION

### Technical Problem

In the above-described method, an operation in the CNN (convolution operation or the like) until a feature map output by the CNN (CNN output feature map) is obtained is speeded up by dedicated hardware. On the other hand, detection processing with a CNN output feature map as an input, which is an output result of the CNN, is not speeded up because the detection processing is implemented by software. Since the CNN output feature map is stored in a dynamic random access memory (DRAM), the detection processing needs to be performed by reading the feature map from the DRAM.

The disclosed technology has been made in view of the above points, and an object thereof is to provide an object detection device, an object detection method, and an object detection program that make it possible to speed up detection processing compared with in the existing technology.

### Solution to Problem

A first aspect of the disclosure is an object detection device including a metadata acquisition unit that acquires metadata including at least a position and a reliability of an object included in an image from a convolutional neural network into which the image is input, a storage unit that stores a feature map value group which is an output result of the convolutional neural network, and a feature map value acquisition unit that reads a feature map value related to the position of the corresponding object from the storage unit to obtain the position of the object only when the reliability obtained by reading a feature map value, which is related to the reliability in the feature map value group stored in the storage unit, from the storage unit exceeds a predetermined threshold value.

A second aspect of the disclosure is an object detection method of causing a processor to execute processes including acquiring metadata including at least a position and reliability of an object included in an image from a convolutional neural network into which the image is input, storing a feature map value group which is an output result of the convolutional neural network, and reading a feature map value related to the position of the corresponding object from the storage unit to obtain the position of the object only when the reliability obtained by reading a feature map value, which is related to the reliability in the stored feature map value group, exceeds a predetermined threshold value.

A third aspect of the disclosure is an object detection program causing a computer to execute processes including acquiring metadata including at least a position and reliability of an object included in an image from a convolutional neural network into which the image is input, storing a feature map value group which is an output result of the convolutional neural network, and reading a feature map value related to the position of the corresponding object from the storage unit to obtain the position of the object only when the reliability obtained by reading a feature map value, which is related to the reliability in the stored feature map value group, exceeds a predetermined threshold value.

### Advantageous Effects of Invention

According to the disclosed technology, it is possible to provide an object detection device, an object detection method, and an object detection program that make it possible to speed up detection processing compared with in the existing technology.

### BRIEF DESCRIPTION OF DRAWINGS

FIG. 1 is a diagram showing a processing flow of a CNN including detection processing.

FIG. 2 is a flowchart showing detection processing performed by an object detection device according to a comparative example of an embodiment.

FIG. 3 is a diagram showing the detection processing shown in FIG. 2.

FIG. 4 is a block diagram showing a hardware configuration of the object detection device.

FIG. 5 is a block diagram showing an example of functional configurations of the object detection device.

FIG. 6 is a flowchart showing a flow of object detection processing performed by the object detection device.

FIG. 7 is a diagram showing the detection processing shown in FIG. 6.

FIG. 8 is a graph showing comparison of the numbers of times of reading of a feature map between a method according to the embodiment and a method according to the comparative example.

FIG. 9 is a flowchart showing a flow of object detection processing performed by the object detection device.

### DESCRIPTION OF EMBODIMENTS

Hereinafter, an example of an embodiment of the disclosed technology will be described with reference to the drawings. In the drawings, the same or equivalent components and portions are denoted by the same reference numerals. Dimensional ratios in the drawings are exaggerated for convenience of description, and may differ from actual ratios.

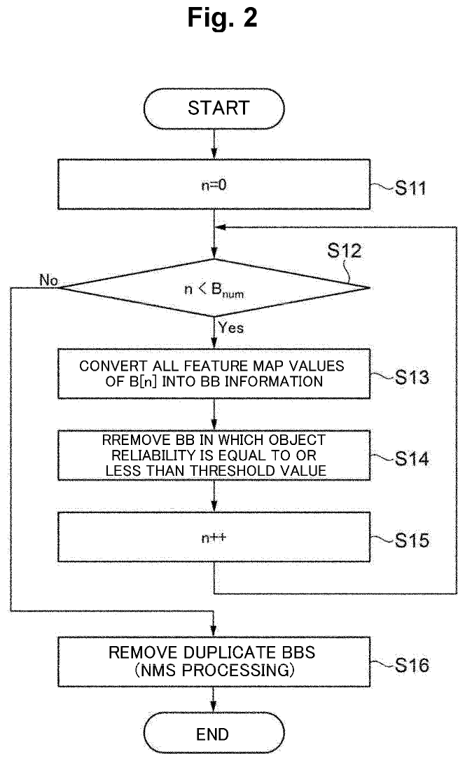

First, description will be given of detection processing performed by an object detection device according to a comparative example of the present embodiment. FIG. 2 is a flowchart showing the detection processing of the object detection device according to the comparative example of the present embodiment.

In the detection processing according to the comparative example, the object detection device first initializes a variable n used in the detection processing to n=0 (step S11). When the variable n is initialized to n=0, the object detection device then determines whether n is less than Bₙᵤₘ (step S12). When n is less than Bₙᵤₘ as a result of the determination in step S12 (step S12; Yes), the object detection device then converts all feature map values of the B[n] into BB information (step S13).

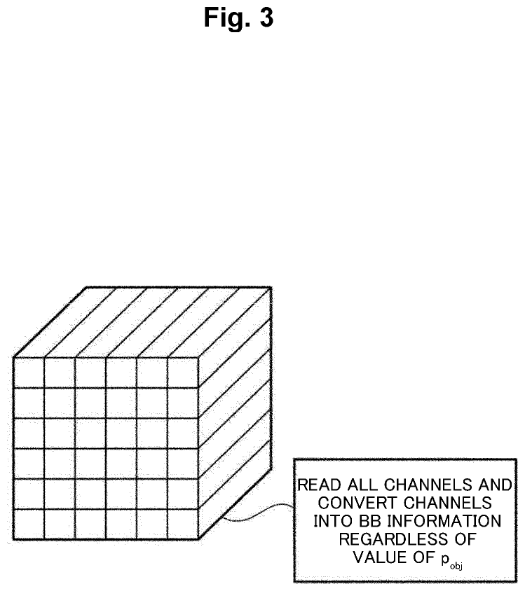

FIG. 3 is a diagram showing the detection processing shown in FIG. 2 and is a diagram showing step S13 in the flowchart shown in FIG. 2. The object detection device converts all of the feature map values of B[n] into the BB information in step S13 of FIG. 2, but reads all channels independently of a value (p_{obj}) corresponding to an object reliability and converts them into BB information. The number of channels Ch is Ch=Bₙᵤₘ×(5+Cₙᵤₘ). In the above equation, 5 is equivalent to five channels tx, ty, tw, th, and p_{obj}.

When the feature map values of B[n] are converted into the BB information, the object detection device then removes a BB in which an object reliability is equal to or less than a threshold value (step S14), and increments the variable (n) by one (step S15).

When n is equal to or more than Bₙᵤₘ (step S12; No) as a result of the determination in step S12, the object detection device then removes duplicate BBs by NMS (step S16). The NMS is processing for excluding BBs with low scores when predicted BBs are repeated.

In this manner, in the detection processing according to the comparative example, all feature map values of all channels of a CNN output feature map are read and converted into BB information. For this reason, for example, when the width (W) and the height (H) of a feature map value are set to 72, Bₙᵤₘ is set to 3, and Cₙᵤₘ is set to 80, 72×72× 255=1321920 feature map values are read from a DRAM. In this manner, in the detection processing according to the comparative example, the number of feature map values to be read increases significantly, and a processing time is increased.

The present embodiment shows an object detection device capable of reducing a processing time as compared with the detection processing according to the comparative example.

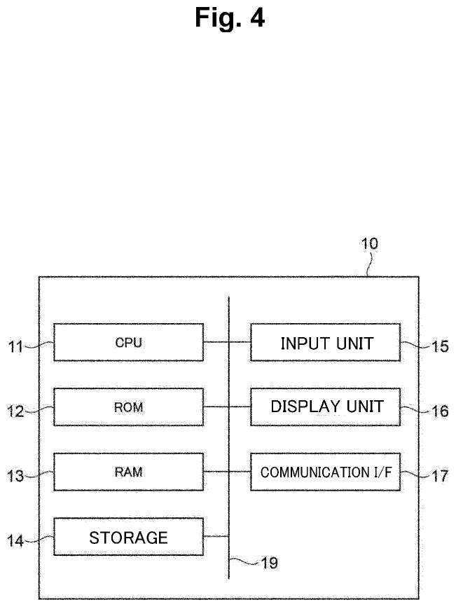

FIG. 4 is a block diagram showing a hardware configuration of an object detection device 10.

As shown in FIG. 4, the object detection device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11, which is a central processing unit, executes various programs or controls each unit. That is, the CPU 11 reads a program from the ROM 12 or the storage 14 and executes the program using the RAM 13 as a work area. The CPU 11 performs control of the above-described components and various types of arithmetic processing in accordance with programs stored in the ROM 12 or the storage 14. In the present embodiment, the ROM 12 or the storage 14 stores an object detection program for detecting an object included in an input image.

Various programs and various types of data are stored in the ROM 12. A program or data is temporarily stored in the RAM 13 that serves as a work area. The storage 14 is constituted by a storage device such as a hard disk drive (HDD) or a solid state drive (SSD), and stores various programs including an operating system and various types of data. The input unit 15 includes a pointing device such as a mouse, and a keyboard, and is used for various inputs.

The display unit 16 is, for example, a liquid crystal display, and displays various types of information. The display unit 16 may function as the input unit 15 by adopting a touch panel system.

The communication interface 17 is an interface for performing communication with other equipment. For the communication, for example, a wired communication standard such as Ethernet (registered trademark) or FDDI, or a wireless communication standard such as 4G, 5G, or Wi-Fi (registered trademark) is used.

Next, functional configurations of the object detection device 10 will be described.

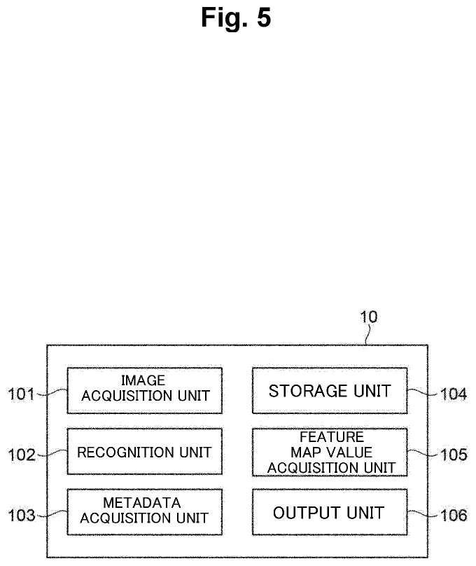

FIG. 5 is a block diagram showing an example of the functional configurations of the object detection device 10.

As shown in FIG. 5, the object detection device 10 includes, as functional configurations, an image acquisition unit 101, a recognition unit 102, a metadata acquisition unit 103, a storage unit 104, a feature map value acquisition unit 105, and an output unit 106. The functional configurations are realized when the CPU 11 reads the object detection program stored in the ROM 12 or the storage 14, expands the read program in the RAM 13, and executes the program.

The image acquisition unit 101 acquires an image of an object detection target.

The recognition unit 102 performs image processing on the image acquired by the image acquisition unit 101, and recognizes an object included in the image. The recognition unit 102 inputs the image acquired by the image acquisition unit 101 to a convolutional neural network (CNN). The CNN outputs metadata including at least the position of the object included in the image and the reliability of the object. The metadata is temporarily stored in the storage unit 104 by the metadata acquisition unit 103 to be described later. The feature map value acquisition unit 105 reads the stored metadata satisfying a predetermined condition.

The metadata acquisition unit 103 acquires metadata including at least the position and reliability of an object included in the input image from the CNN to which the image is input. The reliability may include a class-by-class reliability group for each class of an object. Further, the reliability may include an object reliability indicating the degree of accuracy of the presence of an object.

The storage unit 104 stores a feature map value group which is an output result of the CNN. The feature map value group is a set of feature map values corresponding to predetermined Bₙᵤₘ BB (B[0] to B[Bₙᵤₘ−1]) for each unit referred to as a Grid obtained by dividing an image of horizontal W pixels by vertical H pixels. The storage unit 104 may be provided, for example, in the RAM 13.

The feature map value acquisition unit 105 reads a feature map value related to the position of the corresponding object from the storage unit 104 only when the reliability obtained by reading the feature map value related to the reliability from the storage unit 104 exceeds a predetermined threshold value in the feature map value group stored in the storage unit 104, thereby obtaining the position of the object. The threshold value can be changed depending on a required detection accuracy.

The feature map value acquisition unit 105 reads a feature map value related to the position of the corresponding object and a feature map value related to a class-by-class reliability from the storage unit 104 only when the object reliability obtained from the feature map value related to the object reliability exceeds a threshold value.

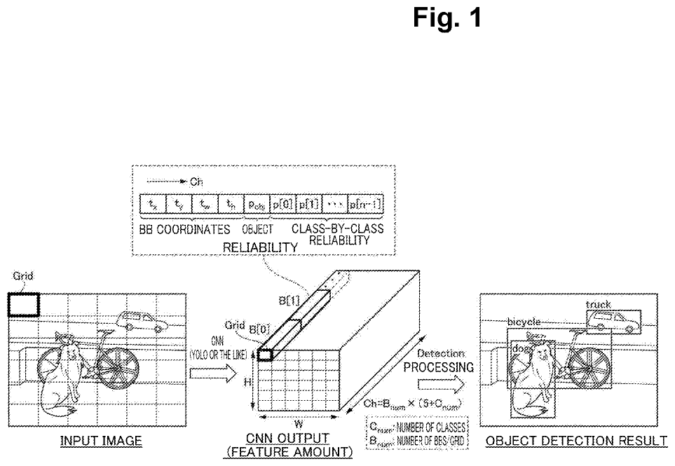

The output unit 106 outputs a result of object recognition performed by the recognition unit 102. The result of the image recognition performed by the recognition unit 102 can be output in a state of being superimposed on the input image. For example, as shown in FIG. 1, the output unit 106 may output a result of image recognition in a state in which a frame is superimposed on a region corresponding to an object of an input image and the name of a detected object is superimposed in the frame.

Next, operations of the object detection device 10 will be described.

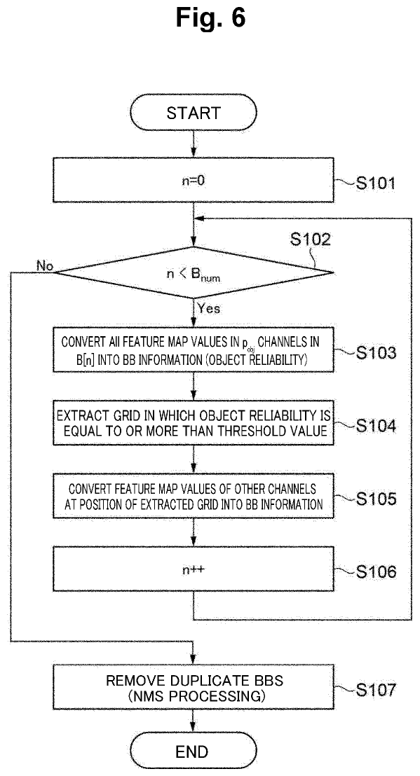

FIG. 6 is a flowchart showing a flow of object detection processing performed by the object detection device 10. The object detection processing is performed when the CPU 11 reads an object detection program from the ROM 12 or the storage 14, expands the read program in the RAM 13, and executes the program.

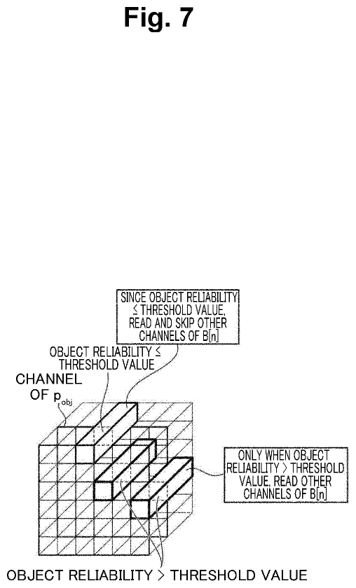

The flowchart shown in FIG. 6 is related to detection processing performed on a CNN output feature map that is output by a CNN and stored in, for example, the RAM 13. FIG. 7 is a diagram illustrating the detection processing shown in FIG. 6.

The CPU 11 initializes a variable n used in the detection processing to 0 (step S101). Subsequently, the CPU 11 determines whether the variable n is less than Bₙᵤₘ (step S102). When the variable n is less than Bₙᵤₘ as a result of the determination in step S102 (step S102; Yes), the CPU 11 converts all feature map values in p_{obj} channels in B[n] into BB information (object reliability) (step S103).

Subsequently to step S103, the CPU 11 extracts a grid in which an object reliability is equal to or higher than a predetermined threshold (step S104).

Subsequently to step S104, the CPU 11 reads feature map values of channels (channels of tx, ty, tw, th, p[0] to p[Cₙᵤₘ−1]) other than the p_{obj} channels at the position of the extracted grid and converts the read feature map values into BB information (step S105). tx, ty, tw, and th are values corresponding to the coordinates of BBs, p[0] to p[Cₙᵤₘ−1] are values corresponding to the reliability of each class of object, and p[0] to p[Cₙᵤₘ−1] are collectively referred to as a class-by-class reliability group.

Subsequently to step S105, the CPU 11 increments the variable n by one (step S106) and returns to the determination processing in step S102.

When n is equal to or more than Bₙᵤₘ (step S102; No) as a result of the determination in step S102, the CPU 11 removes BB in which an object reliability obtained as a result of the conversion into the BB information is equal to or less than a threshold value and removes duplicate BBs (step S107). The CPU 11 removes BBs by non-maximum-suppression (NMS). The NMS is processing for excluding BBs with low scores when predicted BBs are repeated.

In this manner, in the present embodiment, the object detection device 10 exhaustively reads the feature map values of the p_{obj} channels, but reads feature map values of other channels only when the object reliability obtained from p_{obj} exceeds a threshold value.

By the series of processing shown in FIG. 6, reading of a feature map value corresponding to a BB which has an object reliability being equal to or less than a threshold value and is to be removed is omitted except for p_{obj}, and the number of times of reading of a feature map value can be reduced. FIG. 7 shows a state in which reading of a feature map value corresponding to a BB which has an object reliability being equal to or less than a threshold value and is to be removed is omitted except for p_{obj}. When the number of BBs in which an object reliability exceeds a threshold value is K and the number of classes is Cₙᵤₘ, the number of times of reading R of a feature map value in the present embodiment is expressed by the following equation.

$$R = K \times ( 4 + {C}_{num} ) + W \times H \times {B}_{num}$$

In the above equation, W×H×Bₙᵤₘ is the number of times required to read all p_{obj}. This is because a feature map size in a channel is W×H, and the number of p_{obj} channels is Bₙᵤₘ which is equal to the number obtained by dividing the number of BBs by the number of grids. The number of channels for each BB is 4+Cₙᵤₘ except for the p_{obj} channels. Here, 4 is equivalent to four channels of tx, ty, tw, and th. Since these channels are read only when an object reliability obtained from the corresponding p_{obj} exceeds a threshold value, the number of times of reading is K×(4+Cₙᵤₘ).

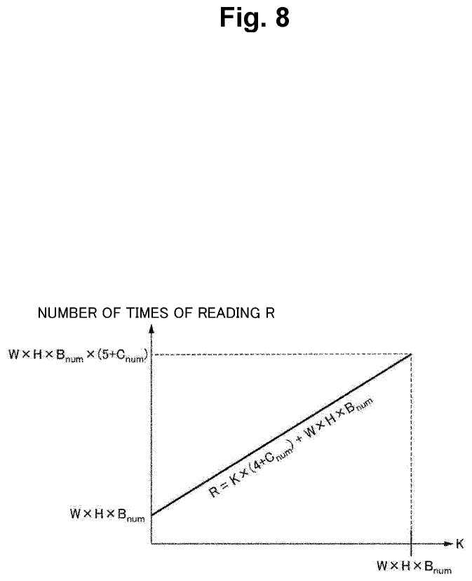

FIG. 8 is a graph showing comparison of the numbers of times of reading of a feature map between a method according to the present embodiment and a method according to the comparative example. In the method according to the comparative example, feature map values of all channels of all grids are read, and thus the number of times of reading is fixed. On the other hand, in the method according to the present embodiment, the number of times is proportional to K. For example, when K=100, Cₙᵤₘ=80, Bₙᵤₘ=3, and W=H=72, R=23952. In this case, in the method according to the present embodiment, the number of times of reading is equal to or less than 1/50 as compared with 1321920 times in the comparative example.

Depending on the type of CNN used for object detection performed by the object detection device 10, an object reliability may not be included in a BB. A method of reducing the number of times of reading of a feature map even in this case will be described below. Specifically, when an object reliability is not included in a BB, the object detection device 10 exhaustively reads the feature maps of the p[0] to p[Cₙᵤₘ−1] channels of the class-by-class reliability group. The object detection device 10 reads feature map values of grids corresponding to the other channels of tx, ty, tw, and th only when any one reliability (class reliability) for each class obtained from p[0] to p[Cₙᵤₘ−1] of the class-by-class reliability group is equal to or more than a threshold value.

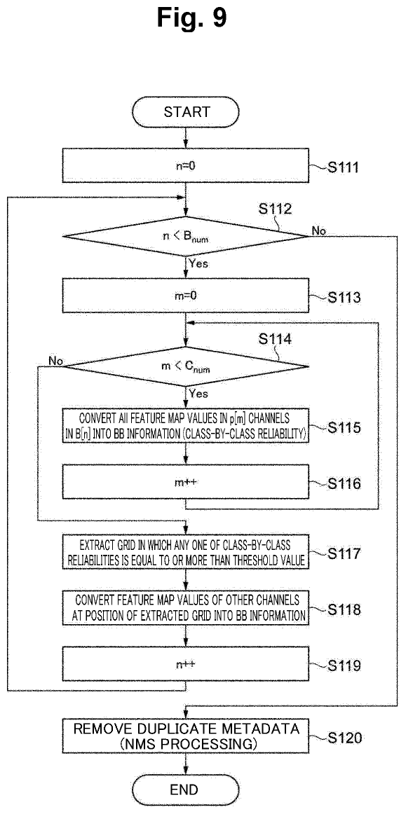

FIG. 9 is a flowchart showing a flow of object detection processing performed by the object detection device 10. The object detection processing is performed when the CPU 11 reads an object detection program from the ROM 12 or the storage 14, expands the read program in the RAM 13, and executes the program.

The flowchart shown in FIG. 9 is related to detection processing performed on a CNN output feature map that is output by a CNN and stored in, for example, the RAM 13.

The CPU 11 initializes a variable n used in the detection processing to 0 (step S111).

Subsequently, the CPU 11 determines whether the variable n is less than Bₙᵤₘ (step S112). When the variable n is less than Bₙᵤₘ as a result of the determination in step S112 (step S112; Yes), the CPU 11 initializes a variable m used in the detection processing to 0 (step S113).

Subsequently, the CPU 11 determines whether the variable m is less than Cₙᵤₘ (step S114). When the variable m is less than Cₙᵤₘ (step S114; Yes) as a result of the determination in step S114, the CPU 11 converts all feature map values in p[m] channels in B[n] into BB information (class-by-class reliability) (step S115).

Subsequently, the CPU 11 increments the variable m by one (step S116) and returns to the determination in step S114.

When the variable m is equal to or more than Cₙᵤₘ as a result of the determination in step S114 (step S114: No), the CPU 11 then extracts a grid in which any of p[0] to p[Cₙᵤₘ−1] of the class-by-class reliability group is equal to or more than a threshold value (step S117).

Subsequently, the CPU 11 reads feature map values of channels (channels of tx, ty, tw, and th) other than the p[0] to p[Cₙᵤₘ−1] channels of the class-by-class reliability group at the position of the extracted grid and converts the read feature map values into BB information (step S118).

Subsequently to step S118, the CPU 11 increments the variable n by one (step S119) and returns to the determination processing in step S112.

When the variable n is equal to or more than Bₙᵤₘ (step S112; No) as a result of the determination in step S112, the CPU 11 removes BB in which an object reliability obtained as a result of the conversion into the BB information is equal to or less than a threshold value and removes duplicate BBs (step S120). The CPU 11 removes BBs by non-maximum-suppression (NMS). The NMS is processing for excluding BBs with low scores when predicted BBs are repeated.

By the series of processing, reading of a feature map value corresponding to a BB which has a class-by-class reliability group being equal to or less than a threshold value and is to be removed is omitted, and the number of times of reading of a feature map value can be reduced.

The object detection processing executed by the CPU reading the software (program) in the above-described embodiments may be executed by various processors other than the CPU. Examples of the processors used in this case include a programmable logic device (PLD) such as a field-programmable gate array (FPGA) of which a circuit configuration can be changed after manufacturing and a dedicated electrical circuit that is a processor having a circuit configuration such as an application specific integrated circuit (ASIC) dedicated and designed to execute specific processing. The object detection processing may be executed by one of the various processors or may be executed by a combination of two or more of the same type or different types of the processors (for example, a plurality of FPGAs, a combination of a CPU and a FPGA, or the like). More specifically, the hardware structure of these various processors is an electrical circuit combining circuit elements such as semiconductor elements.

Although a mode in which an object detection processing program is stored (installed) in advance in the storage 14 has been described in the above-described embodiments, the disclosure is not limited thereto. The program may also be provided in a form in which the program is stored in a non-transitory storage medium such as a compact disk read only memory (CD-ROM), a digital versatile disk read only memory (DVD-ROM), or a Universal Serial Bus (USB) memory. The program may be downloaded from an external device via a network.

The following appendices are further disclosed in relation to the embodiments described above.

### (Appendix 1)

An object detection device including:
a memory; and
at least one processor connected to the memory,
wherein the processor is configured to
acquire metadata including at least a position and reliability of an object included in an image from a convolutional neural network into which the image is input,
store a feature map value group which is an output result of the convolutional neural network, and
read a feature map value related to the position of the corresponding object from the storage unit to obtain the position of the object only when the reliability obtained by reading a feature map value, which is related to the reliability in the stored feature map value group, from the storage unit exceeds a predetermined threshold value.

### (Appendix 2)

A non-transitory storage medium storing a program executable by a computer so as to execute object detection processing,
wherein the object detection processing includes:
acquiring metadata including at least a position and reliability of an object included in an image from a convolutional neural network into which the image is input;
storing a feature map value group which is an output result of the convolutional neural network; and
reading a feature map value related to the position of the corresponding object from the storage unit to obtain the position of the object only when the reliability obtained by reading a feature map value, which is related to the reliability in the stored feature map value group, from the storage unit exceeds a predetermined threshold value.

### REFERENCE SIGNS LIST

10 Object detection device
101 Image acquisition unit
102 Recognition unit
103 Metadata acquisition unit
104 Storage unit
105 Feature map value acquisition unit
106 Output unit

1. An object detection device comprising:
a memory; and
at least one processor connected to the memory,
wherein the processor is configured to
acquire metadata including at least a position and reliability of an object included in an image from a convolutional neural network into which the image is input,
store a feature map value group which is an output result of the convolutional neural network, and
read a feature map value related to the position of the corresponding object from the storage unit to obtain the position of the object only when the reliability obtained by reading a feature map value, which is related to the reliability in the stored feature map value group, from the storage unit exceeds a predetermined threshold value.

2. The object detection device according to claim 1, wherein the reliability includes an object reliability indicating a degree of accuracy of presence of the object and a class-by-class reliability group for each class of the object.

3. The object detection device according to claim 2, wherein the feature map value acquisition unit reads, from the storage unit, a feature map value related to a position of the corresponding object and a feature map value related to the class-by-class reliability group only when an object reliability obtained from a feature map value related to the object reliability exceeds the threshold value.

4. The object detection device according to claim 1, wherein the reliability includes a class-by-class reliability group for each class of the object.

5. The object detection device according to claim 4, wherein the feature map value acquisition unit reads a feature map value related to a position of the corresponding object from the storage unit only when at least one of the class-by-class reliability groups obtained from feature map values related to the class-by-class reliability groups of the object exceeds the threshold value.

6. The object detection device according to claim 1, further comprising:
an output unit that outputs a recognition result of the object using the convolutional neural network.

7. An object detection method of causing a processor to execute processes comprising:
acquiring metadata including at least a position and reliability of an object included in an image from a convolutional neural network into which the image is input;
storing a feature map value group which is an output result of the convolutional neural network; and
reading a feature map value related to the position of the corresponding object to obtain the position of the object only when the reliability obtained by reading a feature map value, which is related to the reliability in the stored feature map value group, exceeds a predetermined threshold value.

8. A non-transitory storage medium storing a program executable by a computer so as to execute object detection processing,
wherein the object detection processing includes:
acquiring metadata including at least a position and reliability of an object included in an image from a convolutional neural network into which the image is input;
storing a feature map value group which is an output result of the convolutional neural network; and
reading a feature map value related to the position of the corresponding object from the storage unit to obtain the position of the object only when the reliability obtained by reading a feature map value, which is related to the reliability in the stored feature map value group, from the storage unit exceeds a predetermined threshold value.
